(19) United States
(12) Patent Application Publication
(10) Pub. No.: US 2025/0357485 A1
(43) Pub. Date: Nov. 20, 2025

(54) ELECTRODE FOR BATTERY

(71) Applicant: TOYOTA JIDOSHA KABUSHIKI KAISHA, Toyota-shi (JP)

(72) Inventors: Daiki Maeda, Toyota-shi (JP); Masataka Tomita, Nisshin-shi (JP); Junta Takasu, Nagoya-shi (JP); Yuusuke Shimizu, Kosai-shi (JP)

(73) Assignee: TOYOTA JIDOSHA KABUSHIKI KAISHA, Toyota-shi (JP)

(21) Appl. No.: 19/052,575

(22) Filed: Feb. 13, 2025

(30) Foreign Application Priority Data
May 20, 2024 (JP) 2024-081649

(51) Int. Cl. H01M 4/587; H01M 4/02; H01M 4/133

(52) U.S. Cl. CPC H01M 4/587; H01M 4/133; H01M 2004/027

(57) ABSTRACT

An electrode for battery includes a base material and a negative electrode active material layer. The negative electrode active material layer is disposed on a surface of the base material. The negative electrode active material layer includes graphite and a binder. The negative electrode active material layer has a basis weight of 25 mg/cm² or more and a density of from 1.2 g/cm³ to 1.6 g/cm³. An area fraction of the binder in an entire section parallel with a thickness direction of the negative electrode active material layer is 1.9% or more. The section includes a first region and a second region. The first region is disposed between the second region and the base material. Relationships of “1.0<(τ1/τ2)<4.4” and “τ2<2.1” are satisfied. Symbol “τ1” represents a tortuosity in the first region. Symbol “τ2” represents a tortuosity in the second region.

### CROSS-REFERENCE TO RELATED APPLICATION

This application claims priority to Japanese Patent Application No. 2024-081649 filed on May 20, 2024, incorporated herein by reference in its entirety.

### BACKGROUND

### 1. Technical Field

The present disclosure relates to an electrode for battery.

### 2. Description of Related Art

Japanese Unexamined Patent Application Publication (Translation of PCT Application) No. 2023-537139 (JP 2023-537139 A) discloses a negative electrode plate in which a tortuosity of a first negative electrode active material layer (a deep portion) is smaller than a tortuosity of a second negative electrode active material layer (a shallow portion).

### SUMMARY

The present disclosure has an object to improve a rate characteristic.

1. An electrode for battery includes a base material and a negative electrode active material layer. The negative electrode active material layer is disposed on a surface of the base material. The negative electrode active material layer includes graphite and a binder. The negative electrode active material layer has a basis weight of 25 mg/cm² or more and a density of from 1.2 g/cm³ to 1.6 g/cm³. An area fraction of the binder in an entire section parallel with a thickness direction of the negative electrode active material layer is 1.9% or more. The section includes a first region and a second region. The first region is disposed between the second region and the base material. Relationships of “1.0<(τ1/τ2)<4.4” and “τ2<2.1” are satisfied. Symbol “τ1” represents a tortuosity in the first region, and symbol “τ2” represents a tortuosity in the second region.

During long-term discharge, lithium (Li) ions move from a shallow portion to a deep portion of the negative electrode active material layer. The tortuosity represents complexity of a Li-ion moving path (an air gap) in the thickness direction of the negative electrode active material layer. As the tortuosity comes closer to 1, the moving path is considered to be simpler (linear). As the tortuosity departs from 1 to the larger side, the moving path is considered to be complex. As the tortuosity comes closer to 1, the supply of Li ions in the thickness direction is promoted, and hence the rate characteristic is considered to be improved.

In order to enhance the energy density, a negative electrode active material layer having a high basis weight and a high density is desired. However, a high basis weight and a high density increase the tortuosity. That is, a high basis weight and a high density reduce the rate characteristic. The negative electrode active material layer includes a binder in addition to the negative electrode active material (graphite). In order to reduce the reduction in rate characteristic due to the high basis weight and the high density, it is also conceivable to reduce the binder. The reduction of the binder increases the air gap (the Li-ion moving path). That is, improvement in rate characteristic can be expected. However, on the other hand, shortage of the binder may cause insufficient bonding strength between the negative electrode active material layer and the base material. Due to these circumstances, in the related art, it has been difficult to achieve the tortuosity of less than 2.1 under conditions of the high basis weight of 25 mg/cm² or more, the high density of 1.2 g/cm³ or more, and the binder amount of 1.9% or more.

In the present disclosure, two regions that are different in tortuosity are provided in the negative electrode active material layer. In this manner, in the negative electrode active material layer having the high basis weight and the high density, while a sufficient bonding strength is maintained, the rate characteristic is improved. The first region may also be referred to as “deep portion”, “deep layer”, and the like. The first region is disposed on a side relatively closer to the base material as compared with the second region. The second region may also be referred to as “shallow portion”, “front layer”, or the like. The second region is disposed on a side relatively closer to the surface of the negative electrode active material layer as compared with the first region. A ratio “τ1/τ2” of the tortuosity “τ1” of the first region to the tortuosity “τ2” of the second region is more than 1.0 and less than 4.4. When the ratio “τ1/τ2” of the tortuosity is 1.0 or less, the moving distance of Li ions in the shallow portion becomes relatively long, and hence the usage rate of the negative electrode active material in the deep portion may be reduced. When the ratio “τ1/τ2” of the tortuosity is more than 1, the moving distance of Li ions in the shallow portion becomes relatively short, and hence the usage rate of the negative electrode active material in the deep portion may be improved. Through improvement of the usage rate of the negative electrode active material in the deep portion, the improvement in rate characteristic can be expected. However, when the ratio “τ1/τ2” of the tortuosity becomes 4.4 or more, the movement of Li ions in the deep portion may become difficult. As a result, the usage rate of the negative electrode active material in the deep portion may be rather reduced. Thus, in the present disclosure, the ratio “τ1/τ2” of the tortuosity is specified to be more than 1.0 and less than 4.4.

2. The electrode for battery according to Item “1” may include the following configuration, for example. An area fraction of the binder in the first region may be 2.9% or more. An area fraction of the binder in the second region may be 1.0% or less.

When the binder amount in the first region (the deep portion) is relatively large, the improvement in bonding strength can be expected. When the binder amount in the second region (the shallow portion) is relatively small, the ratio “τ1/τ2” of the tortuosity in the second region tends to easily take a value of more than 1.

3. The electrode for battery according to Item “1” or “2” may include the following configuration, for example. The graphite may include artificial graphite. The graphite of 80% or more in mass fraction with respect to a total amount of the graphite may have an aspect ratio of 1.6 or less.

When the percentage of the artificial graphite having the aspect ratio of 1.6 or less is 80% or more, the improvement in rate characteristic can be expected.

4. The electrode for battery according to any one of Items “1” to “3” may include the following configuration, for example. The negative electrode active material layer may satisfy the following relationship: “0.033≤I₍₁₁₀₎/I₍₀₀₂₎”. “I₍₁₁₀₎” represents a diffraction intensity of the (110) plane in an X-ray diffraction profile of the negative electrode active material layer. “I₍₀₀₂₎” represents a diffraction intensity of the (002) plane in the X-ray diffraction profile of the negative electrode active material layer.

The ratio “I₍₁₁₀₎/I₍₀₀₂₎” of the diffraction intensity is an index of an orientation state. Hereinafter, the ratio “I₍₁₁₀₎/I₍₀₀₂₎” of the diffraction intensity is also referred to as “degree of orientation”. As the degree of orientation is higher, the major axis of the graphite particle is considered to be along the thickness direction of the negative electrode active material layer. When the degree of orientation is 0.033 or more, the improvement in rate characteristic can be expected. For example, at the time of drying a slurry, a magnetic field may be applied to align the graphite along the thickness direction of the negative electrode active material layer.

5. The electrode for battery according to any one of Items “1” to “4” may include the following configuration, for example. In the section, an area fraction of the second region with respect to the entire negative electrode active material layer may be from 50% to 70%.

When the area fraction of the second region is from 50% to 70%, the improvement in rate characteristic can be expected.

Hereinafter, description is given of an embodiment of the present disclosure (which may be hereinafter simply referred to as “this embodiment”) and an example of the present disclosure (which may be hereinafter simply referred to as “this example”). It is to be noted that this embodiment and this example do not limit the technical scope of the present disclosure. This embodiment and this example are illustrative in any respect. This embodiment and this example are non-restrictive. The technical scope of the present disclosure encompasses any modifications within the meaning and the scope equivalent to the terms of the claims. For example, from the beginning, it is planned to extract appropriate configurations from this embodiment and combine them as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating an example of an electrode for battery in this embodiment; and

FIG. 2 is a table illustrating experiment results.

### DETAILED DESCRIPTION OF EMBODIMENTS

### Terms and Phrases

Any geometric term should not be interpreted solely in its exact meaning. Examples of geometric terms include “parallel”, “perpendicular”, and “orthogonal”. For example, within a range in which substantially the same or similar functions can be obtained, the direction, the angle, the distance, or the like may be relatively displaced. The geometric terms may include, for example, a tolerance, an error, and the like in terms of design, operation, manufacturing, and the like. A dimensional relation in each of the figures may not coincide with an actual dimensional relation. In order to facilitate the understanding of the reader, the dimensional relation in each figure may be changed. For example, the length, the width, the thickness, or the like may be changed. In some cases, some configurations may be omitted.

A numerical range such as “from m % to n %” includes both the upper limit value and the lower limit value unless particularly noted. That is, “from m % to n %” indicates a numerical range of “m % or more and n % or less”. Further, “m % or more and n % or less” includes “more than m % and less than n %”. “Equal to or more than” and “equal to or less than” are represented by inequality signs with equality signs of “≤, ≥”. “More than” and “less than” are represented by inequality signs without equality signs of “<, >”. Any numerical value selected from a certain numerical range may be used as a new upper limit value or a new lower limit value. For example, any numerical value from a certain numerical range may be combined with any numerical value described in another part of the present specification or in a table or a drawing to set a new numerical range.

All the numerical values are regarded as being modified by the term “about”. The term “about” may mean±5%, ±3%, ±1%, and the like, for example. All numerical values may be approximate values that may vary depending on the implementation mode of the technique of the present disclosure. All numerical values may be represented by significant digits. Each measured value may be the average value obtained from a plurality of times of measurement unless particularly noted. The number of times of measurement may be three or more, five or more, or ten or more. Generally, the greater the number of times of measurement is, the more reliable the average value is expected to be. Each measured value may be rounded off based on the number of the significant figures. Each measured value may include an error occurring due to a detection limit of a measurement apparatus, for example.

The “basis weight” of the negative electrode active material layer represents a mass per unit area of the negative electrode active material layer. A unit of “mg/cm²” is used as the unit of the basis weight. The “density” of the negative electrode active material layer represents the apparent density of the negative electrode active material layer. The apparent density is obtained by dividing the basis weight of the negative electrode active material layer by the thickness of the negative electrode active material layer. A unit of “g/cm³” is used as the unit of the density. The basis weight and the density are measured at five or more locations in the negative electrode active material layer. An arithmetic mean of measurement of the five or more locations is adopted.

The “tortuosity” of each region is measured by the following method. A focused ion beam scanning electron microscopy (FIB-SEM) is prepared. With the FIB, slicing processing is carried out once on a sample (negative electrode active material layer) for each thickness of 50 nm, and SEM scanning is carried out so that a sectional SEM image (tomographic image) is acquired. The operation is repeated a plurality of times. A three-dimensional structure is reconfigured from all acquired tomographic images so that a 3D image of the negative electrode active material layer is acquired. Simulation software “GeoDict” (produced by Math2Market GmbH) is used to analyze the 3D image. Thus, the tortuosities “τ1, τ2” of the respective regions are obtained.

The “area fraction” of the binder is measured by the following method. For example, in the sectional sample of the negative electrode active material layer, binder dyeing processing may be carried out. For example, styrene-butadiene rubber (SBR) may be dyed with osmium oxide. Through energy dispersive X-ray spectrometry (SEM-EDX), in the sectional sample, mapping analysis of the binder is carried out. A pixel corresponding to the binder in the negative electrode active material layer is counted. The area fraction of the binder in the negative electrode active material layer is obtained by dividing the number of pixels corresponding to the binder by the number of pixels of the entire negative electrode active material layer. The area fraction is represented by percentage (%). The area fraction of the binder in each region may be similarly measured.

The “aspect ratio” of graphite is measured by the following method. A sectional sample is produced by cutting the negative electrode active material layer. The sectional sample includes a section parallel with the thickness direction of the negative electrode active material layer. For example, a cross-section polisher (registered trademark) or the like may be used to clean an observation target portion. Through observation of the sectional sample with the SEM, a sectional SEM image is acquired. In the sectional SEM image, ten or more pieces (particles) of graphite are randomly extracted. In the extracted particles, a major axis diameter and a minor axis diameter are measured. The major axis diameter “φ1” represents a diameter connecting two points that are most separated from each other on a contour line of the particle. The minor axis diameter “φ2” represents the maximum diameter out of diameters orthogonal to the major axis diameter. The aspect ratio is a ratio “φ1/φ2” of the major axis diameter to the minor axis diameter. An arithmetic mean of ten or more aspect ratios is regarded as the “aspect ratio”.

The “degree of orientation” of the negative electrode active material layer is measured by the following method. Through X-ray diffraction (XRD), an XRD profile of the negative electrode active material layer is measured. An X-ray source is a CuKα beam. The measurement range is “10°≤2θ≤90°”. In the XRD profile, the diffraction peak of the (002) plane may be detected in a range of “25°≤2θ≤30°”. The area (integrated intensity) of the diffraction peak of the (002) plane is the diffraction intensity “I₍₀₀₂₎”. The diffraction peak of the (110) plane may be detected in a range of “75°≤2θ≤80°”. The area of the diffraction peak of the (110) plane is the diffraction intensity “I₍₁₁₀₎”. The degree of orientation “I₍₁₁₀₎/I₍₀₀₂₎” is obtained by dividing the diffraction intensity “I₍₁₁₀₎” by the diffraction intensity “I₍₀₀₂₎”.

### Electrode for Battery

One aspect of the present disclosure resides in an electrode for battery. Another aspect of the present disclosure resides in a battery including an electrode for battery. The present disclosure may be applied to any battery. Examples of the battery include a monopolar battery, a bipolar battery, a non-aqueous battery, and a lithium ion battery.

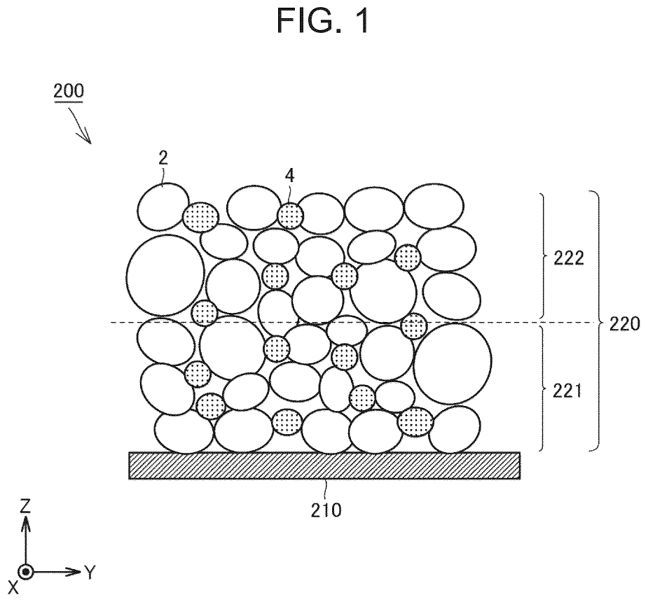

FIG. 1 is a schematic sectional view illustrating an example of an electrode for battery according to this embodiment. Hereinafter, the electrode for battery may be simply referred to as “electrode”. An electrode 200 may be, for example, in a sheet shape. The electrode 200 may be, for example, a negative electrode of a monopolar lithium ion battery. A section of FIG. 1 is parallel with the thickness direction (Z direction) of the electrode 200. The electrode 200 includes a base material 210 and a negative electrode active material layer 220.

The base material 210 supports the negative electrode active material layer 220. The base material 210 may be, for example, in a sheet shape. The thickness of the base material 210 may be, for example, from 1 μm to 50 μm, from 3 μm to 30 μm, or from 5 μm to 15 μm. The base material 210 has electrical conductivity. The base material 210 may include, for example, a metal foil or the like. The base material 210 may include, for example, at least one type selected from the group consisting of Cu, Ni, Zn, Pb, Al, Ti, Fe, Ag, Au, and an electrically conductive resin. The base material 210 may include, for example, a Cu foil, a Cu alloy foil, and the like. The base material 210 may have, for example, a multilayer structure. For example, the base material 210 may be formed by bonding a Cu foil and an Al foil to each other.

The negative electrode active material layer 220 is disposed on the surface of the base material 210. The negative electrode active material layer 220 may be disposed only on one surface of the base material 210. The negative electrode active material layers 220 may be disposed on both surfaces of the base material 210. When the electrode 200 is used for a bipolar battery, the negative electrode active material layer 220 may be disposed on one surface (a front surface) of the base material 210, and a positive electrode active material layer (not shown) may be disposed on the other surface (a back surface).

The thickness of the negative electrode active material layer 220 may be, for example, 10 μm or more, 50 μm or more, 100 μm or more, 150 μm or more, 200 μm or more, 300 μm or more, 400 μm or more, or 500 μm or more. The thickness of the negative electrode active material layer 220 may be, for example, 1,000 μm or less, 500 μm or less, 400 μm or less, 300 μm or less, or 200 μm or less.

The basis weight of the negative electrode active material layer 220 is 25 mg/cm² or more. The basis weight of the negative electrode active material layer 220 may be, for example, 30 mg/cm² or more, 35 mg/cm² or more, 40 mg/cm² or more, 45 mg/cm² or more, or 50 mg/cm² or more. The basis weight of the negative electrode active material layer 220 may be, for example, 100 mg/cm² or less, 75 mg/cm² or less, 50 mg/cm² or less, 40 mg/cm² or less, or 30 mg/cm² or less.

The density of the negative electrode active material layer 220 is from 1.2 g/cm³ to 1.6 g/cm³. When the density exceeds 1.6 g/cm³, it may become difficult to achieve a desired tortuosity. The density of the negative electrode active material layer 220 may be, for example, 1.3 g/cm³ or more, 1.4 g/cm³ or more, or 1.5 g/cm³ or more. The density of the negative electrode active material layer 220 may be, for example, 1.5 g/cm³ or less, 1.4 g/cm³ or less, or 1.3 g/cm³ or less.

The negative electrode active material layer 220 includes a first region 221 and a second region 222. The negative electrode active material layer 220 may consist of the first region 221 and the second region 222. Each region may form a layer. The first region 221 is disposed between the second region 222 and the base material 210. The first region 221 may be, for example, in direct contact with the base material 210. The first region 221 may include, for example, an interface between the base material 210 and the negative electrode active material layer 220. The second region 222 may include, for example, the surface of the negative electrode active material layer 220. That is, the second region 222 may be exposed on the surface of the negative electrode active material layer 220.

In the section of the negative electrode active material layer 220, the area fraction of the second region 222 with respect to the entire negative electrode active material layer 220 may be, for example, from 50% to 70%. The area fraction of the second region 222 may be, for example, 60% or more or 60% or less. In the same section, the area fraction of the first region 221 with respect to the entire negative electrode active material layer 220 may be, for example, from 30% to 50%. The area fraction of the first region 221 may be, for example, 40% or more or 40% or less. It is to be noted that, in the section of the negative electrode active material layer 220, the area fraction of each region with respect to the entire negative electrode active material layer 220 is considered to be equal to a ratio of the thickness of each region to the thickness of the negative electrode active material layer 220 in the same section.

The negative electrode active material layer 220 may further include additional regions (a third region, a fourth region, and the like) in addition to the first region 221 and the second region 222. The additional region may be distinguished from the first region 221 and the second region 222 by, for example, at least one of a composition and a structure. For example, an additional region may be disposed between the base material 210 and the first region 221. For example, an additional region may be disposed between the first region 221 and the second region 222. For example, an additional region may be disposed between the surface of the negative electrode active material layer 220 and the second region 222.

The second region 222 has a tortuosity smaller than that of the first region 221. A ratio “τ1/τ2” of a tortuosity “τ1” of the first region 221 to a tortuosity “τ2” of the second region 222 is more than 1.0 and less than 4.4. The ratio “τ1/τ2” of the tortuosity may be, for example, 1.2 or more, 1.6 or more, 2.0 or more, 2.4 or more, 2.8 or more, 3.2 or more, 3.6 or more, or 4.0 or more. The ratio “τ1/τ2” of the tortuosity may be, for example, 4.0 or less, 3.6 or less, 3.2 or less, 3.0 or less, less than 3.0, 2.8 or less, 2.4 or less, 2.0 or less, 1.6 or less, or 1.2 or less.

It is to be noted that the tortuosity “τ2” of the second region 222 is less than 2.1. The tortuosity “τ2” of the second region 222 may be, for example, 2.0 or less, 1.9 or less, 1.8 or less, 1.7 or less, 1.6 or less, 1.5 or less, 1.4 or less, 1.3 or less, 1.2 or less, or 1.1 or less. The tortuosity “τ2” of the second region 222 may be, for example, 1 or more, 1.1 or more, 1.2 or more, 1.3 or more, 1.4 or more, 1.5 or more, 1.6 or more, 1.7 or more, 1.8 or more, 1.9 or more, or 2.0 or more.

The tortuosity “τ1” of the first region 221 may be, for example, 2.1 or more, 2.5 or more, 3.0 or more, 3.5 or more, 4.0 or more, 4.5 or more, 5.5 or more, 6.0 or more, 6.5 or more, 7.0 or more, 7.5 or more, or 8.0 or more. The tortuosity “τ1” of the first region 221 may be, for example, less than 8.5, 8.0 or less, 7.5 or less, 7.0 or less, 6.5 or less, 6.0 or less, 5.5 or less, 5.0 or less, 4.5 or less, 4.0 or less, 3.5 or less, 3.0 or less, or 2.5 or less.

The tortuosity of each region may be adjusted by any method. For example, “separate coating” may be carried out. That is, multilayer coating may be carried out with the use of two types of slurries having different compositions. The tortuosity tends to be reduced as the binder amount is reduced. For example, a magnetic field may be applied to a coating film (a slurry), for example. The magnetic field aligns the graphite, and hence the tortuosity tends to be reduced. For example, the drying temperature of the coating film may be adjusted. As the drying temperature becomes lower (as the drying speed becomes slower), the tortuosity tends to be reduced. For example, those methods may be combined as appropriate so that the negative electrode active material layer 220 satisfying relationships of “1.0<(τ1/τ2)<4.4” and “τ2<2.1” may be formed.

The negative electrode active material layer 220 includes graphite 2 and a binder 4. The negative electrode active material layer 220 may consist of, for example, in mass fraction, the binder 4 of from 0.1% to 10% and the graphite 2 as the balance. The section of the negative electrode active material layer 220 may consist of, in area fraction, the binder 4 of 1.9% or more and the graphite 2 as the balance. The negative electrode active material layer 220 may further include, for example, an electrically conductive material, a thickener, or an inorganic filler in addition to the graphite 2 and the binder 4.

Each of the first region 221 and the second region 222 independently includes the graphite 2 and the binder 4. The graphite 2 included in the first region 221 may be the same type as or a different type from the graphite 2 included in the second region 222. The binder 4 included in the first region 221 may be the same type as or a different type from the binder 4 included in the second region 222. The graphite is a negative electrode active material. Each of the first region 221 and the second region 222 may further include an additional negative electrode active material in addition to the graphite. Each of the first region 221 and the second region 222 may include, for example, at least one type selected from the group consisting of silicon (Si), silicon oxide (SiO), a silicon carbon composite material (Si—C), a silicon-based alloy, tin, tin oxide, and lithium titanate. The mass fraction of the other negative electrode active material with respect to the total negative electrode active material may be, for example, 50% or less, 40% or less, 30% or less, 20% or less, 10% or less, 5% or less, or 1% or less.

The graphite may be natural graphite or artificial graphite. The surface of the graphite may be covered with a carbon material. The carbon material may include, for example, soft carbon, hard carbon, amorphous carbon, low crystallinity carbon, or the like. D50 of the graphite may be, for example, 1 μm or more, 5 μm or more, or 10 μm or more. D50 of the graphite may be, for example, 30 μm or less, 20 μm or less, 15 μm or less, or 10 μm or less. “D50” represents a particle size in volume-based particle size distribution (cumulative distribution) at which the cumulative value reaches 50%. The particle size distribution may be measured by a laser diffraction method.

The aspect ratio of the graphite may be, for example, from 1 to 4. The aspect ratio of the graphite may be, for example, 1.2 or more, 1.4 or more, 1.6 or more, 2.0 or more, 2.3 or more, 2.8 or more, 3.2 or more, or 3.6 or more. The aspect ratio of the graphite may be, for example, 3.6 or less, 3.2 or less, 2.8 or less, 2.3 or less, 2.0 or less, 1.6 or less, 1.4 or less, or 1.2 or less. For example, the graphite of 80% or more in mass fraction with respect to the total amount of the graphite may have an aspect ratio of 1.6 or less. The percentage of the graphite having the aspect ratio of 1.6 or less may be, for example, 85% or more, 90% or more, or 95% or more. The percentage of the graphite having the aspect ratio of 1.6 or less may be, for example, 100% or less, 95% or less, 90% or less, or 85% or less.

The degree of orientation “I₍₁₁₀₎/I₍₀₀₂₎” of the graphite may be, for example, 0.033 or more. The degree of orientation may be, for example, 0.050 or more or 0.075 or more. The degree of orientation may be, for example, 0.100 or less, 0.075 or less, or 0.050 or less.

The binder 4 may include, for example, at least one type selected from the group consisting of SBR, acrylate butadiene rubber (ABR), polyacrylonitrile (PAN), polyvinylidene fluoride (PVdF), polytetrafluoroethylene (PTFE), acrylic resin (acrylic acid ester copolymer), methacrylic resin (methacrylic acid ester copolymer), polyvinyl alcohol (PVA), and derivatives thereof.

In the section of the negative electrode active material layer 220, the area fraction of the binder 4 with respect to the entire negative electrode active material layer 220 is 1.9% or more. The same area fraction may be, for example, 2.5% or more, 3.0% or more, 3.5% or more, 4.0% or more, 4.5% or more, or 5.0% or more. The same area fraction may be, for example, 10% or less, 7.5% or less, 7.0% or less, 6.5% or less, 6.0% or less, 5.5% or less, 5.0% or less, 4.5% or less, 4.0% or less, 3.5% or less, 3.0% or less, or 2.5% or less.

In the negative electrode active material layer 220, the binder 4 may be uniformly distributed, for example. In the negative electrode active material layer 220, for example, the distribution of the binder 4 may have unevenness. For example, the area fraction of the binder 4 in the first region 221 may be higher than the area fraction of the binder 4 in the second region 222. The area fraction of the binder 4 in the first region 221 may be, for example, 2.9% or more. The area fraction of the binder 4 in the first region 221 may be, for example, 3.0% or more, 3.5% or more, 4.0% or more, 4.5% or more, or 5.0% or more. The area fraction of the binder 4 in the first region 221 may be, for example, 10% or less, 7.5% or less, 7.0% or less, 6.5% or less, 6.0% or less, 5.5% or less, 5.0% or less, 4.5% or less, 4.0% or less, 3.5% or less, 3.0% or less, or 2.5% or less. The area fraction of the binder 4 in the second region 222 may be, for example, 1.0% or less. The area fraction of the binder 4 in the second region 222 may be, for example, 0.9% or less, 0.8% or less, 0.7% or less, 0.6% or less, 0.5% or less, 0.4% or less, 0.3% or less, or 0.2% or less. The area fraction of the binder 4 in the second region 222 may be, for example, 0.1% or more, 0.2% or more, 0.3% or more, 0.4% or more, 0.5% or more, 0.6% or more, 0.7% or more, 0.8% or more, or 0.9% or more.

### Manufacture of Electrode (Negative Electrode)

### No. 1

The following materials were prepared.
Negative electrode active material: artificial graphite (SG), aspect ratio: 1.6
Binder: SBR
Thickener: carboxymethyl cellulose (CMC)
Dispersion medium: water
Base material: Cu foil (thickness: 15 μm)

In No. 1, “separate coating” was carried out. A first slurry was prepared by mixing SG, SBR, CMC, and water. The blending ratio of the solid content was “SG/CMC/SBR=97/0.6/2.4 (mass ratio)”. The first region (the deep portion) was formed by coating the base material with the first slurry. The first region was formed so that the basis weight thereof became 14 mg/cm² after drying.

A second slurry was prepared by mixing SG, SBR, CMC, and water. The blending ratio of the solid content was “SG/CMC/SBR=98.6/0.6/0.8 (mass ratio)”. The second region (the shallow portion) was formed by applying and stacking the second slurry onto the first slurry. The second region was formed so that the basis weight thereof became 14 mg/cm² after drying. That is, the total basis weight is 28 mg/cm².

A magnetic field was applied to the coating film (the first region and the second region). The negative electrode active material layer was formed by drying the coating film after the application of the magnetic field. The drying temperature (the hot air temperature) was 50° C. The electrode (the negative electrode) was manufactured by compressing the negative electrode active material layer. After the compression, the density of the negative electrode active material layer was 1.2 g/cm³.

### No. 2

The electrode was manufactured similarly to No. 1 except that no magnetic field was applied to the coating film.

### No. 3

In No. 3, the negative electrode active material layer was formed without carrying out separate coating. A slurry was prepared by mixing SG, SBR, CMC, and water. The blending ratio of the solid content was “SG/CMC/SBR=98.8/0.6/1.6 (mass ratio)”. The coating film was formed by coating the base material with the slurry. A magnetic field was applied to the coating film. The negative electrode active material layer was formed by drying the coating film after the application of the magnetic field. The basis weight after drying was 28 mg/cm². The electrode was manufactured by compressing the negative electrode active material layer after the drying. After the compression, the density of the negative electrode active material layer was 1.2 g/cm³.

### No. 4

The electrode was manufactured similarly to No. 1 except that SG having an aspect ratio of 2.3 was used.

### No. 5

The electrode was manufactured similarly to No. 3 except that no magnetic field was applied to the coating film.

### No. 6

The electrode was manufactured similarly to No. 5 except that the drying temperature was changed to 25° C.

### No. 7

The electrode was manufactured similarly to No. 1 except that the amount of the binder in the first slurry was increased.

### Manufacture of Evaluation Cell

The following materials were prepared.
Positive electrode active material: LiNi_{0.8}Co_{0.1}Mn_{0.1}O₂ (NCM)
Electrically conductive material: acetylene black (AB)
Binder: PVdF
Dispersion medium: N-methylpyrrolidone (NMP)
Base material: Al foil (thickness: 30 μm)
Separator: PE-made porous sheet
Electrolyte: LiPF₆ (concentration: 1.0 mol/L), EC+DMC+EMC
Exterior casing: Al laminated film pouch

A slurry was prepared by mixing NCM, AB, PVdF, and NMP. The blending ratio of the solid content was “NCM/AB/PVdF=97.8/0.8/1.4 (mass ratio)”. The positive electrode active material layer was formed by coating the base material with the slurry. The positive electrode active material layer was dried. The positive electrode was manufactured by compressing the positive electrode active material layer.

An electric power generation element was formed by stacking the positive electrode, the separator, and the negative electrode in the stated order. An evaluation cell (rated capacity: 155 mA) was manufactured by sealing the electric power generation element and the electrolyte in the exterior casing.

### Evaluation

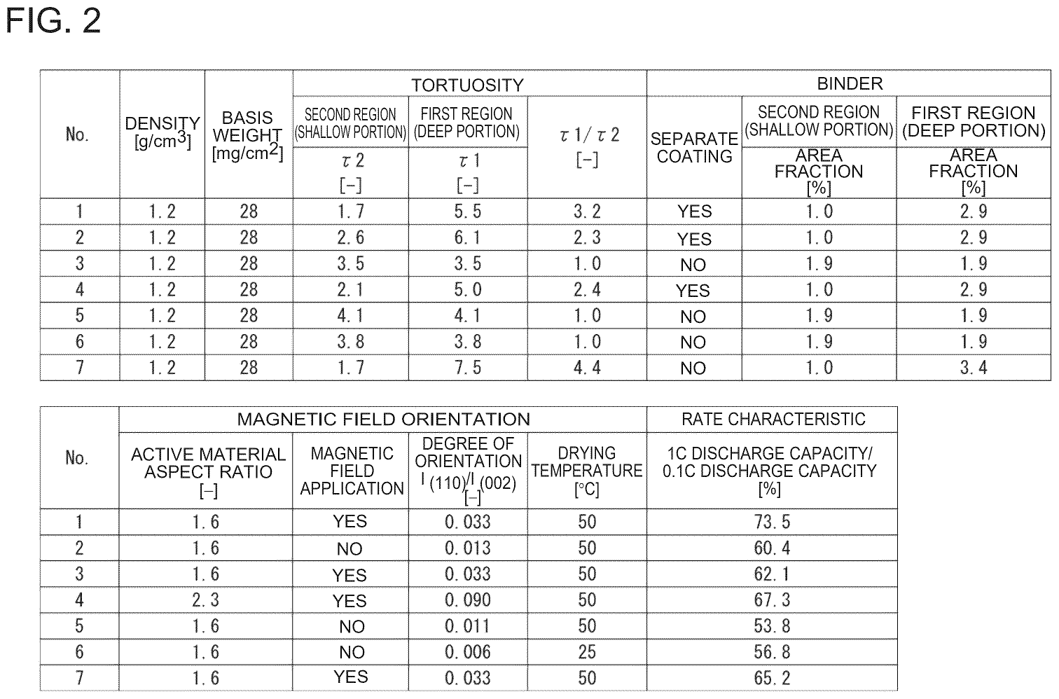

FIG. 2 is a table illustrating the experiment results. The discharge capacity of the evaluation cell was measured at each of the 0.1C rate and the 1C rate. The symbol “C” represents rate. At the 1C rate, the rated capacity is caused to flow in one hour. The value of “1C discharge capacity/0.1C discharge capacity” was obtained by dividing the discharge capacity at the 1C rate (a 1C discharge capacity) by the discharge capacity at the 0.1C rate (a 0.1C discharge capacity). As the value of “1C discharge capacity/0.1C discharge capacity” is larger, the rate characteristic is better.

### Results

### No. 3

The tortuosity tends to be reduced due to the application of the magnetic field (orientation of graphite). However, a tortuosity of less than 2.1 is not achieved.

### No. 6

The tortuosity tends to be reduced due to the binder migration being improved by lowering the drying temperature. However, a tortuosity of less than 2.1 is not achieved.

### No. 2

The tortuosity may be locally reduced due to the separate coating. However, a tortuosity of less than 2.1 is not achieved.

### No. 1

The rate characteristic tends to be improved when the conditions of “1.0<(τ1/τ2)<4.4” and “τ2<2.1” are satisfied.

What is claimed is:

1. An electrode for battery, the electrode comprising:
a base material; and
a negative electrode active material layer, wherein:
the negative electrode active material layer is disposed on a surface of the base material;
the negative electrode active material layer includes graphite and a binder;
the negative electrode active material layer has a basis weight of 25 mg/cm² or more and a density of from 1.2 g/cm³ to 1.6 g/cm³;
an area fraction of the binder in an entire section parallel with a thickness direction of the negative electrode active material layer is 1.9% or more;
the section includes a first region and a second region;
the first region is disposed between the second region and the base material; and
the following relationships are satisfied:
1.0<(τ1/τ2)<4.4; and
τ2<2.1,
where the τ1 represents a tortuosity in the first region, and
the τ2 represents a tortuosity in the second region.

2. The electrode for battery according to claim 1, wherein:
an area fraction of the binder in the first region is 2.9% or more; and
an area fraction of the binder in the second region is 1.0% or less.

3. The electrode for battery according to claim 1, wherein:
the graphite includes artificial graphite; and
the graphite of 80% or more in mass fraction with respect to a total amount of the graphite has an aspect ratio of 1.6 or less.

4. The electrode for battery according to claim 1, wherein the negative electrode active material layer satisfies the following relationship:
0.033≤I₍₁₁₀₎/I₍₀₀₂₎,
where the I₍₁₁₀₎ represents a diffraction intensity of a (110) plane in an X-ray diffraction profile of the negative electrode active material layer, and
the I₍₀₀₂₎ represents a diffraction intensity of a (002) plane in the X-ray diffraction profile of the negative electrode active material layer.

5. The electrode for battery according to claim 1, wherein, in the section, an area fraction of the second region with respect to the entire negative electrode active material layer is from 50% to 70%.
